(19) United States
(12) Patent Application Publication
(10) Pub. No.: US 2015/0178456 A1
(43) Pub. Date: Jun. 25, 2015

(54) REMOTE HEALTH CARE VIA A TELEVISION COMMUNICATION SYSTEM

(71) Applicant: OpenTV, Inc., San Francisco, CA (US)

(72) Inventors: Philippe Stransky-Heilkron, Cheseaux-sur-Lausanne (CH); Nicholas Fishwick, San Francisco, CA (US); Srinivas Chakravarthy Nayani, Bangalore (IN)

(73) Assignee: OpenTV, Inc., San Francisco, CA (US)

(21) Appl. No.: 14/135,271

(22) Filed: Dec. 19, 2013

(51) Int. Cl. G06F 19/00; H04N 21/235; H04N 21/488; H04N 21/81

(52) U.S. Cl. CPC G06F 19/3418; H04N 21/8126; H04N 21/235; H04N 21/4882; G06F 19/3462

(57) ABSTRACT

Methods and systems for providing health care remotely via a television communication system are presented. In one example, a communication gateway configured to communicate with a head-end of a television communication system may receive information associating a user with the communication gateway. Health care information related specifically to the user, as well as a gateway identifier associated with the user, may be received at the gateway from the head-end. The health care information may be forwarded to a display communicatively coupled to the gateway based on the gateway identifier corresponding to the communication gateway.

### FIELD

This application relates generally to the field of electronic communications and, in an example embodiment, to providing health care remotely via a television communication system.

### BACKGROUND

As the overall costs of providing health care continue to increase, the ability of the health care system to provide such care to certain segments of the population in a cost-effective manner becomes increasingly difficult. For example, at least some older people may want to either postpone or reject the possibility of living in an assisted living facility for any of a number of reasons, such as, for example, a lack of funds to pay for such a living arrangement, a desire to save accumulated assets, or a longing to preserve their independence. However, such a person, in some circumstances, may benefit from more frequent attention from health care professionals than what was needed earlier in life. In other examples, people living in rural or remote areas may be located tens or hundreds of miles from a properly staffed or equipped health care center, such as a hospital or an urgent care facility. Further, the building of such a facility may be impractical or impossible in view of what may be limited financial resources of the community. In both cases, as well as others not specifically discussed herein, more creative methods of delivering health care information and services remotely to various segments of the population, at least from time to time, may reduce overall health care costs while increasing the overall quality of the health care being provided.

### BRIEF DESCRIPTION OF DRAWINGS

Embodiments are illustrated by way of example and not limitation in the figures of the accompanying drawings, in which like references indicate similar elements and in which:

FIG. 1 is a block diagram of an example television communication system employable for providing some aspects of health care remotely to one or more user premises;

FIGS. 2A, 2B, and 2C are block diagrams of example arrangements of equipment at a user premises in the television communication system of FIG. 1;

FIG. 3 is a block diagram of an example head-end of the television communication system of FIG. 1;

FIG. 4 is a block diagram of an example communication gateway of the television communication system of FIG. 1;

FIG. 5 is a flow diagram of an example method of providing health care information remotely;

FIG. 6 is a flow diagram of an example method of providing diagnostic information remotely;

FIGS. 7A, 7B, 7C, and 7D are example interface screens for a health delivery program or application;

FIG. 8 is a flow diagram of an example method of scheduling visits, such as health-related visits, to a user of a television communication system;

FIG. 9 is a flow diagram of an example method of warning a user of an imminent arrival of a scheduled visitor;

FIG. 10A is a flow diagram of an example method of detecting the presence of a user to provide scheduling information to the user;

FIG. 10B is a flow diagram of an example method of logging the presence of a visitor;

FIG. 11 is a flow diagram of an example method of detecting and processing a biological metric of a user;

FIG. 12 is a flow diagram of an example method of checking the welfare of a user;

FIG. 13 is a graphical representation of an example of a medication dispenser employable to check the medication use of a user;

FIG. 14 is a flow diagram of an example method of checking the medication use of a user; and

FIG. 15 illustrates a diagrammatic representation of a machine in the example form of a computer system within which a set of instructions, for causing the machine to perform any one or more of the methodologies discussed herein, may be executed.

### DETAILED DESCRIPTION

In the following description, for purposes of explanation, numerous specific details are set forth in order to provide a thorough understanding of the embodiments disclosed herein. It will be evident, however, to one skilled in the art that the embodiments may be practiced without these specific details.

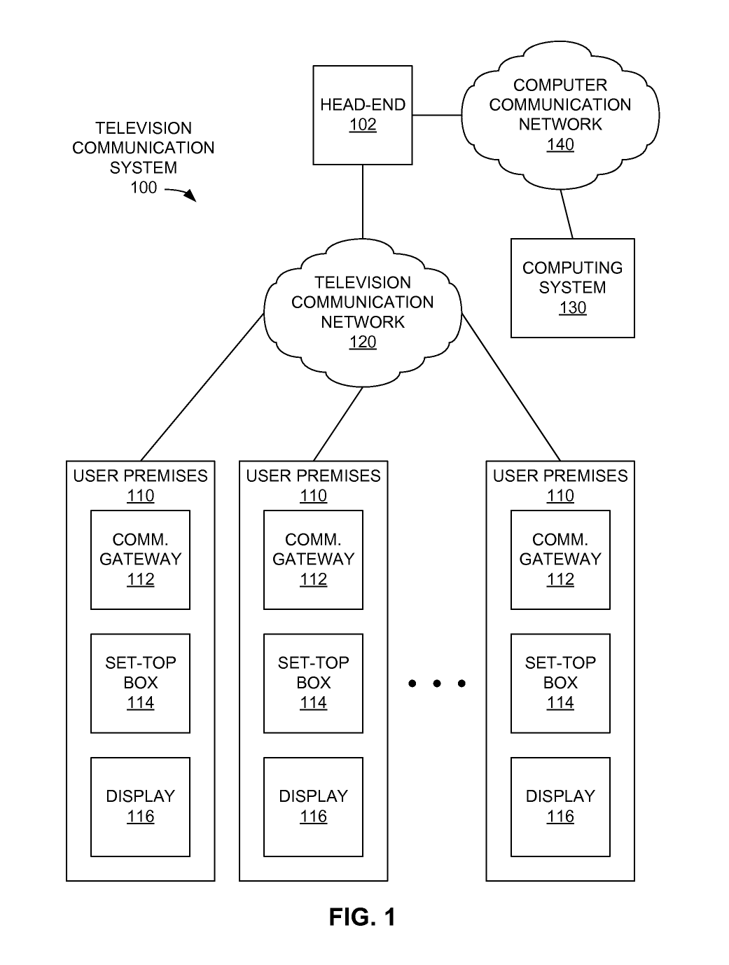

FIG. 1 is a block diagram of an example television communication system 100 employable for providing one or more forms of health care remotely. The television communication system 100 may include, but is not limited to, a digital broadcast system (e.g., a satellite television system or a cable television system), a video-on-demand system, and a video streaming system.

The television communication system 100 may include a head-end (e.g., a head-end server) 102 and equipment located at one or more user premises 110. While FIG. 1 depicts three user premises 110, fewer or greater numbers of user premises 110 may be included in other embodiments. The head-end 102 may be coupled with each of the user premises 110 via a television communication network 120. The television communication network 120 may include a path for delivering live and/or stored television content, electronic program guide (EPG) data, data for purchasing items and/or services, and so on from the head-end 102 to the user premises 110. The television communication network 120 may also receive information, such as, for example, requests for particular television programs, purchase orders for various items and/or services, and the like, at the head-end 102 from the user premises 110. In some examples, data transmitted from the head-end 102 to the user premises 110 may travel over a different physical path than data transmitted from the user premises 110 to the head-end 102.

The head-end 102 may be, for example, a satellite television head-end system, a cable television head-end system, a terrestrial television head-end system, and/or a video-on-demand head-end system for delivering television content and related services to the user premises 110. The head-end 102 may receive such content from one or more content providers (not shown in FIG. 1). The head-end 102 may also communicate with a computing system 130 by way of a computer communication network 140 (e.g., a wide-area network (WAN) (such as the Internet, an Intranet, or a wireless cellular network), a local-area network (LAN) (such as a WiFi® network or Ethernet network), and/or any other communication network). The computer communication network 140 may facilitate communication of any number of users, including users associated with one or more of the user premises 110, with the head-end 102.

As shown in FIG. 1, the user premises 110 may include a communication gateway 112, a set-top box 114, and a display 116. The display 116 may be, for example, a flat panel display, a cathode ray tube (CRT), or any other display device configured to display broadcast television programming, video-on-demand content, electronic program guide (EPG) content, and other information of interest to a user. The set-top box 114 may be any device configured to process data received from the head-end 102 via the television communication network 120 for presentation to the user via the display 116. Such processing may include, for example, channel selection, as well as decryption and decoding of audio and/or video data. The set-top box 114 may also send data to the head-end 102 via the television communication network 120, such as, for example, requests for video-on-demand programming, selection of items and/or services for purchase, and so on.

As described in greater detail below, the communication gateway 112, in conjunction with the head-end 102, provides or facilitates at least some form of health care to a user associated with one or more of the user premises 110. More specifically a user associated with a user premises 110 may be, for example, a medical patient, an elderly person, or any other individual that may benefit from such health care. In addition, users associated with either a user premises 110 or a computing system 130 may include any health care provider or individual associated therewith, including, but not limited to, doctors, nurses, pharmacists, physician's assistants, social workers, and even relatives and friends of those requiring some form of health care. The health care being provided or facilitated may include, but is not limited to, diagnostic information, mediation information, visitation scheduling, and welfare checking.

In at least some embodiments discussed more fully below, at least some form of health care is provided to a user of a communication system that is not only pervasive among the general population, but is a common conduit for entertainment enjoyed by individuals of all walks of life. Other possible benefits will become apparent in light of the various embodiments discussed below.

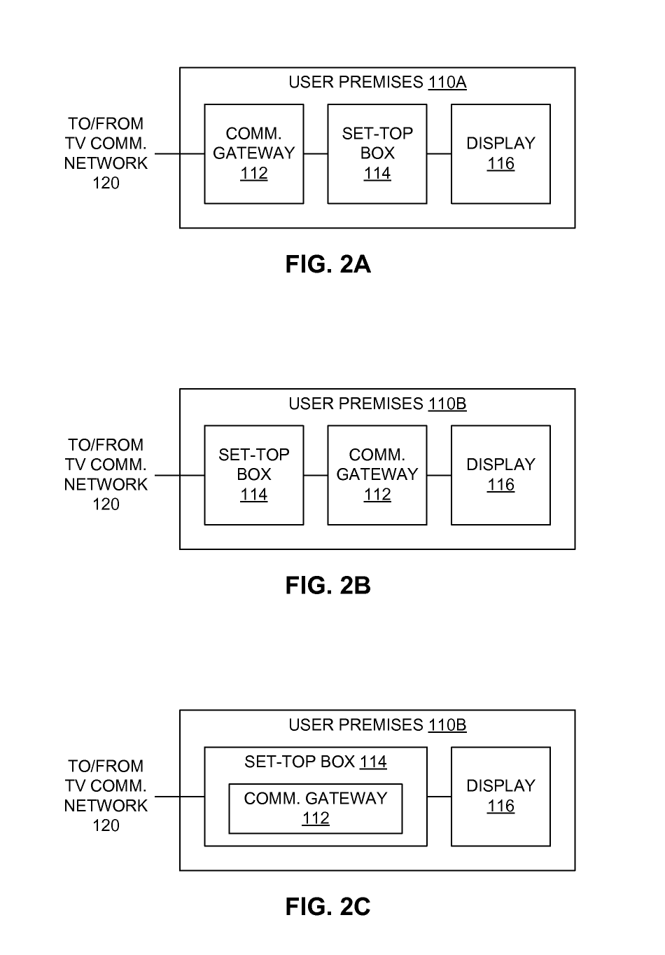

FIGS. 2A, 2B, and 2C are block diagrams of example arrangements of equipment at a user premises, such as the user premises 110 of FIG. 1. In FIG. 2A, the communication gateway 112 may receive the television signals and other data from the head-end 102, and either pass those signals along unmodified to the set-top box 114, or modify (e.g., by way of picture-in-picture (PIP) and/or replace at least a portion of those signals before forwarding them to the set-top box 114, or provide new signals to the set-top box 114) those signals so that they include health care information. In at least some examples, the signals from the head-end 102 may be received at the communication gateway 112 via a coaxial cable, and the signals between the communication gateway 112 and the set-top box 114 may be transported using a High-Definition Multimedia Interface (HDMI) cable, component video cable, composite video cable, or a coaxial cable, for example.

In FIG. 2B, the set-top box 114 receives the television signals and other data from the head-end 102, such as via a coaxial cable, processes those signals as appropriate, and passes those signals to the communication gateway 112. In turn, the communication gateway 112 may replace, modify, or add to one or more of those signals to provide health care information to the display 116 for presentation to the user. Again, coaxial, component, composite, HDMI, and/or other types of audio/video cabling may be utilized to couple the communication gateway 112 with set-top box 114 and the display 116.

In some HDMI implementations, the communication gateway 112 may employ the Consumer Electronics Control (CEC) portion of the HDMI to control the set-top box 114 and/or the display 116 to present the health care information. For example, the communication gateway 112 may direct the set-top box 114 or the display 116 to tune to a particular channel, or to select a different input source, so that the health care information may be provided on the display 116.

As depicted in FIG. 2C, the communication gateway 112 may be physically incorporated within the set-top box 114 in some embodiments, thus performing any of the functions ascribed above to the communication gateway 112. In some other configurations, the display 116, or a second display not shown in FIGS. 2A through 2C, may be incorporated into the communication gateway 112 or the set-top box 114. Further, configurations of the communication gateway 112, the set-top box 114, and the display 116 other than those illustrated in FIGS. 2A through 2C, such as, for example, parallel configuration of the communication gateway 112 and the set-top box 114, are also possible in other implementations.

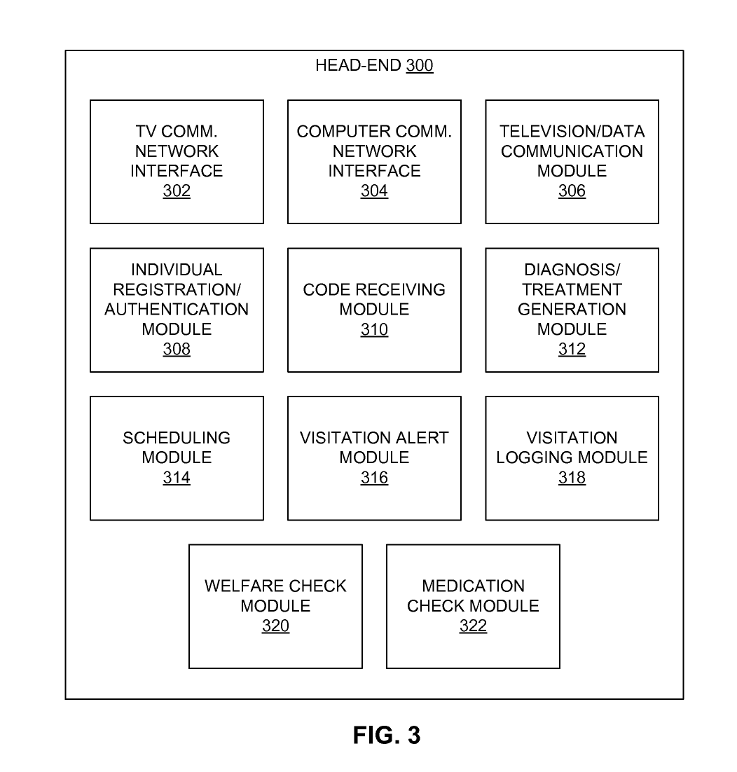

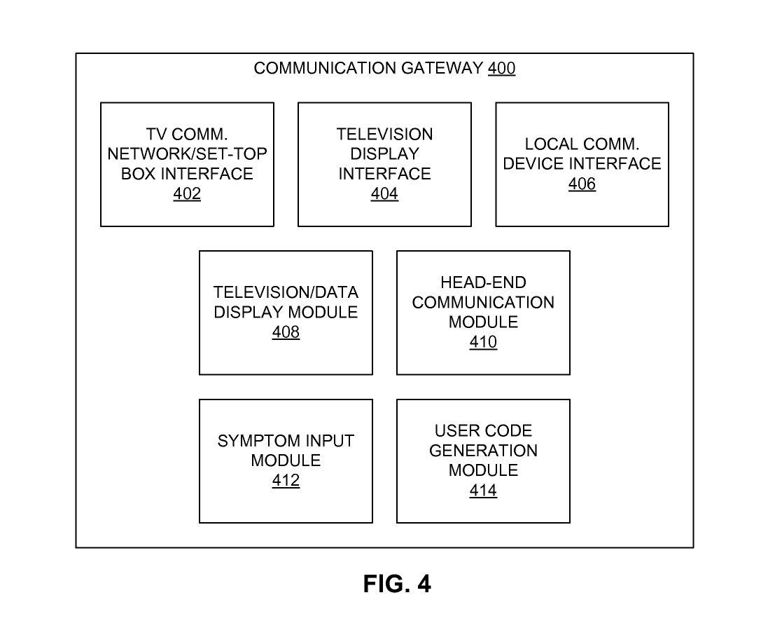

FIG. 3 is a block diagram of an example head-end 300 that may serve, in some examples, as the head-end 102 of FIG. 1. Similarly, FIG. 4 is a block diagram of an example communication gateway 400 that may serve as the communication gateway 112 in at least some implementations. While each of these figures depicts several components, other components, such as one or more processors, one or more memory devices, and the like, are not explicitly depicted in FIG. 3 or FIG. 4 to simplify and focus the following discussion. Also, one or more of the components or modules described in FIGS. 3 and 4 may be hardware modules, software modules stored in memory and executed by one or more processors, or some combination thereof. Further, one or more of the modules depicted in FIGS. 3 and 4 may be omitted in some embodiments. In addition, some components or modules of head-end 300 of FIG. 3 may instead be embodied in the communication gateway 400 of FIG. 4, and vice-versa.

In the example of FIG. 3, the head-end 300 may include a television communication network interface 302, a computer communication network interface 304, a television/data communication module 306, an individual registration/authentication module 308, a code receiving module 310, a diagnosis/treatment generation module 312, a scheduling module 314, a visitation alert module 316, a visitation logging module 318, a welfare check module 320, and a medication check module 322.

The television communication network interface 302 may be configured to facilitate transmission of audio and/or video content to one or more user premises (e.g., the user premises 110 of FIG. 1) via a television communication network (e.g., the television communication network 120 of FIG. 1) by way of, for example, satellite, cable, and/or terrestrial transmission and reception.

The computer communication network interface 304 may be configured to communicate with other systems not directly associated with television-related communications by way of a computer communication network (e.g., the computer communication network 140 of FIG. 1), such as, for example, a WAN, LAN, cellular communication network, and the like. Using the computer communication network interface 304, the head-end 300 may communicate with desktop computers, laptop computers, tablet computers, smart phones, gaming systems, and other computing devices configured to facilitate communication between a user and the head-end 102. In addition, such communications may be formatted as text (e.g., Short Message Service, or SMS) messages, email message, messages resulting from use of an application, and so on, for example.

The television/data communication module 306 may be configured to facilitate the various audio/video content and other data communications discussed further herein by utilizing the television communication network interface 302 and the computer communication network interface 304.

Other modules (e.g., modules 308-322) of the head-end 300 are more specifically related to the health care provisioning functions discussed in greater detail below. For example, the individual registration/authentication module 308 may facilitate registration and authentication or validation of interested parties (e.g., doctors, physician's assistants, nurses, social workers, relatives, and friends) for access to data associated with one or more users (e.g., a medical patient or an elderly individual) of the television communication system (e.g., the television communication system 100 of FIG. 1) associated with the head-end 300. Access of the interested parties may be facilitated by way of, for example, a computing system (e.g., the computing system 130 of FIG. 1, such as a computer, tablet, smart phone, etc.) communicating with the head-end 300 via the computer communication network interface 304, or by way of a communication gateway (e.g., the communication gateway 112 of FIG. 1) coupled with the head-end 300. To register, an interested party may provide identifying information (e.g., name, address, phone numbers, desired username and/or password, etc.) via a computing system 130 to the head-end 300 so that an authenticating mechanism may be provided to the interested party. Such a mechanism may include, for example, an approved username and password to be entered by the interested party using a computing system 130, or a physical card or other device (e.g., a smart phone) that is readable by a card reader or similar interface that is communicatively coupled with a computing system 130 or a communication gateway 112. In some examples, the physical card and the associated reader or interface may communicate via Bluetooth®, near field communication (NFC), radio-frequency identification (RFID), or other communication protocol.

The code receiving module 310 may be configured to receive a code from an interested party that corresponds with a particular user and one or more symptoms exhibited by the user. In one example, a communication gateway 112 generates the code in response to the user entering identifying information (e.g., name, address, phone numbers, etc.) and/or symptom information, and then displays the code to the user or an interested party. The party receiving the code may then provide the code to the code receiving module 310 via some communication means, such as via email or text message.

The diagnosis/treatment generation module 312 may generate a diagnosis and/or proposed treatment intended for the user represented in the code provided to the code receiving module 310. The head-end 300 may then provide the generated diagnosis and/or treatment via the television communication network interface 302 and/or the computer communication network interface 304 to the user and/or interested party.

The scheduling module 314 may facilitate access to, and storing of, scheduling information for visits or appointments between a user and other interested parties (e.g., doctors, social workers, and the like). The scheduling module 314 may indicate when scheduling conflicts occur, and may provide the scheduling information to the user by way of a communication gateway 112 associated with the user. The scheduling module 314 may provide other functions associated with the scheduling information in other embodiments. The scheduling module 314 may store the scheduling information locally in the head-end 300, at a remote location accessible by the head-end 300, or elsewhere.

In conjunction with the scheduling module 314, the visitation alert module 316 may be configured to receive a communication (e.g., an email or text message) from a visitor, such as a visitor associated with a scheduled visit indicated in the scheduling information for a user, indicating that the visitor will be visiting the user shortly. In response, the visitation alert module 316 may deliver a message to the user via the television communication network interface 302 to the communication gateway 112 associated with the user to alert the user of the impending visit. In some examples, the visitation alert module 316 may provide a text or email message to a computing system (e.g., the computing system 130 of FIG. 1, such as a computer, tablet, or smart phone) associated with the user by way of the computer communication network interface 304. In other implementations, the visitor need not have scheduled a visit via the scheduling module 314 for the alert message to be presented to the user. In further embodiment, the visitation alert module 316 may alert the user to scheduled events represented in the scheduling information with the need for a communication from a visitor.

The visitation logging module 318 may be configured to log visits to a user by one or more interested parties by receiving an indication of such a visit at the communication gateway 112 of the user. For example, the visitor may employ a smart phone, physical card, or other device that may communicate with the communication gateway 112, such as via NFC, RFID, or Bluetooth®, to indicate that the visit is taking place. The communication gateway 112 may transmit this information to the head-end 300. In response, the visitation logging module 318 may then log that information for subsequent purposes, such as, for example, alerting scheduled visitors and/or users of missed appointments, tracking appointments or visits by particular visitors for timeliness, and so on.

The welfare check module 320 may be configured to receive information from the communication gateway 112 of the user to determine the current wellbeing of the user. For example, the welfare check module 320 may receive sensor information from the communication gateway 112 indicating whether the user has recently turned on any lights, appliances, or even a television coupled with the communication gateway 112. In some implementations, the welfare check module 320 may also receive information from one or more biometric sensors (e.g., a pulse monitor, a blood pressure monitor, etc.) coupled with the communication gateway 112 to determine a level of health or wellbeing of the user. In an example, the welfare check module 320 may initiate an audio and/or video call with the communication gateway 112 of the user, employing a camera and/or microphone coupled therewith to perform an audio and/or visual check of the user. Such a call may be made in response to sensor information received at the welfare check module 320 indicating a potential wellbeing issue with the user.

The medication check module 322 may be configured to receive information from the communication gateway 112 of the user to determine whether the user has been taking medication according to a prescribed schedule. For example, the welfare check module 320 may receive sensor information from the communication gateway 112 indicating which compartments of a medication dispenser are currently open. Based on the sensor information, the medication check module 322 may initiate a welfare check for the user (such as by way of the welfare check module 320) or an in-person visit to the user.

FIG. 4 is a block diagram of an example communication gateway 400 that may serve, in one embodiment, as the communication gateway 112 of the television communication system of FIG. 1. The communication gateway 400 may include, in some examples, a television communication network/set-top box interface 402, a television display interface 404, a local communication device interface 406, a television/data display module 408, a head-end communication module 410, a symptom input module 412, and a user code generation module 414.

The television communication network/set-top box interface 402 may be configured to facilitate reception of audio and/or video content, along with the transmission and reception of other data related to health care, between a head-end (e.g., the head-end 102 of the television communication system 100 of FIG. 1) via a television communication network (e.g., the television communication network 120 of FIG. 1) by way of a coaxial cable, phone line, and/or other means. In other examples, the television communication network/set-top box interface 402 may be configured to communication with a set-top box (e.g., the set-top box 114 of FIG. 1) for reception and transmission of those same signals by coaxial cable, HDMI cable, and/or other means.

The television display interface 404 may be configured to provide video and/or audio signals received from the head-end 102 and/or the set-top box 114, as well as such signals generated internally within the communication gateway 112, to a display (e.g., the display 116 of FIG. 1) for presentation to the user. Such signals may be provided to the display 116 via HDMI cable, component video cable, composite video cable, and/or other connection means.

The local communication device interface 406 may be configured to receive sensor signals and other communications from any of several sensors and/or communication devices, including, but not limited to, environmental sensors (e.g., light sensors, video cameras, still photo cameras, and microphones), biometric sensors (e.g., pulse monitors, pulse oximeters, and blood pressure monitors), and mobile communication devices (e.g., smart phones, chips, and cards communicating via Bluetooth®, RFID, or NFC). The communication gateway 400 employs these signals and communication devices to facilitate the various operations discussed herein regarding visit logging, welfare checking, medication checking, and the like.

The television/data display module 408 employs the television display interface 404 to process television signals and other data for presentation on the display 116. Such processing may include, for example, generation of a picture-in-picture (PIP) window for presentation of health care information to a user in conjunction with a video signal, such as a television program. In some examples, this processing of the data and video signals may include replacing a video signal for a particular program or channel with the health care information.

The head-end communication module 410 may be configured to facilitate communication between the communication gateway 400 and the head-end 102 to facilitate the providing of health care according to various embodiments described herein. In one example, information from the head-end 102 to the communication gateway 112 may be carried over a different path than that over which information from the communication gateway 112 is transported to the head-end 102.

The symptom input module 412 may be configured to provide a user interface through which a user or interested party may enter personal information and symptom information pertaining to the user. In response to this personal and/or symptom information, the user code generation module 414 may generate a code (described above) that is presented to the user or an interested party, wherein the code represents the user and the symptoms entered via the symptom input module 412. The code may then be transmitted to the head-end 102 via a smart phone or other device (e.g., via email or text message). In response, the head-end 102 may transmit diagnosis/treatment information to the communication gateway 112 to be presented to the user or interested party via the display 116. The head-end 102 may also provide such information to a smart phone or other device for presentation to the user or interested party.

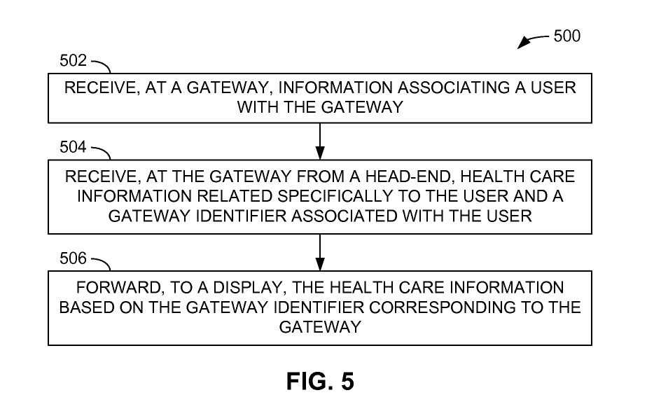

FIG. 5 is a flow diagram of an example method 500 of providing health care information remotely. In the following description, the communication gateway 112 of FIG. 1 is described as performing the operations of the method 500. However, in other implementations, another device or system, such as the set-top box 114, or another device or system not specifically described herein, may perform these operations. In the method 500, information associating a user with the communication gateway 112 is received at the communication gateway 112 (operation 502). In some examples, the information may be provided by the user, another user, or some other person or system. Also received at the communication gateway 112, from a head-end (e.g., the head-end 102 of FIG. 1), is health care information related specifically to the user and a gateway identifier associated with the user (operation 504). The health care information is forwarded to a display (e.g., the display 116 of FIG. 1) for presentation based on the gateway identifier corresponding to the gateway (operation 506). In at least some implementations, the health care information may be any type of information (e.g., diagnosis information, treatment information, visit scheduling information, and so on). Also, depending on the implementation, the communication gateway 112 may be most closely associated with the user, a different user (e.g., a doctor or other health care provider), or a third party.

While the operations 502 through 506 of FIG. 5 (as well as the operations of other methods illustrated herein) are shown as occurring in a specific order, other orders of operation, including concurrent execution of two or more operations, are also possible.

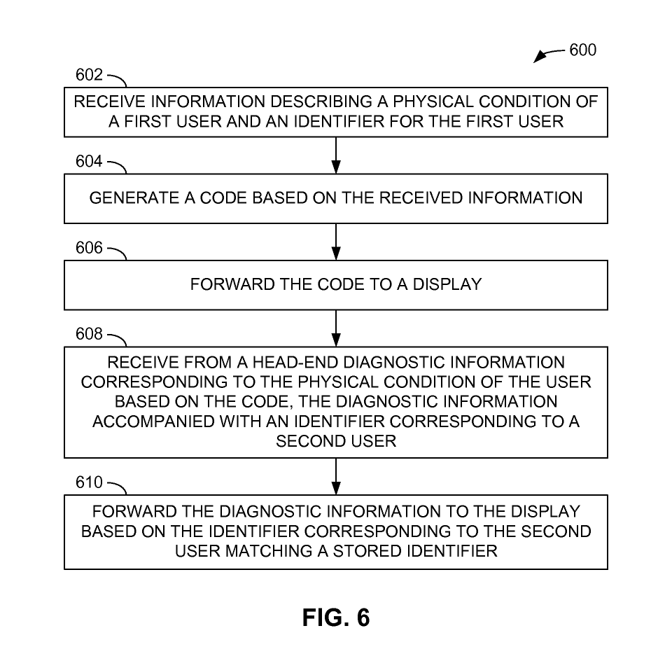

FIG. 6 is a flow diagram of an example method 600 of providing diagnostic information remotely. Such diagnostic information may include treatment information in at least some implementations. In this particular example, a communication gateway 112 may perform the method 600, although a set-top box (e.g., the set-top box 114 of FIG. 1) or another device may perform the method 600 in other embodiments. In a particular example, the communication gateway 112 may be located at a remote health facility, such as a rural health center at which access to qualified health care providers may be limited.

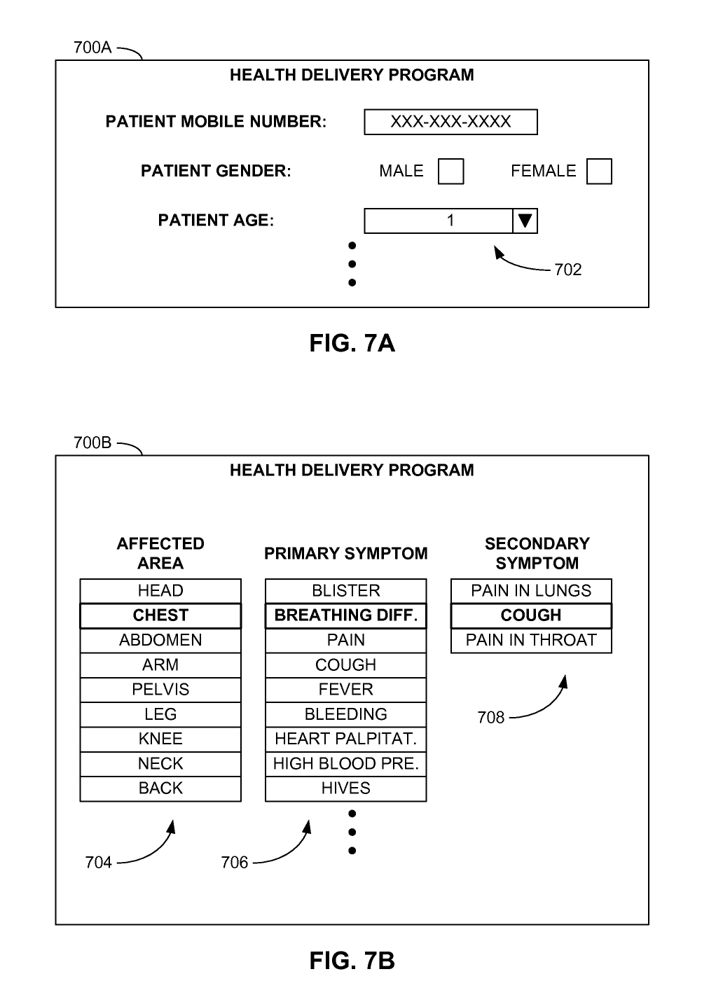

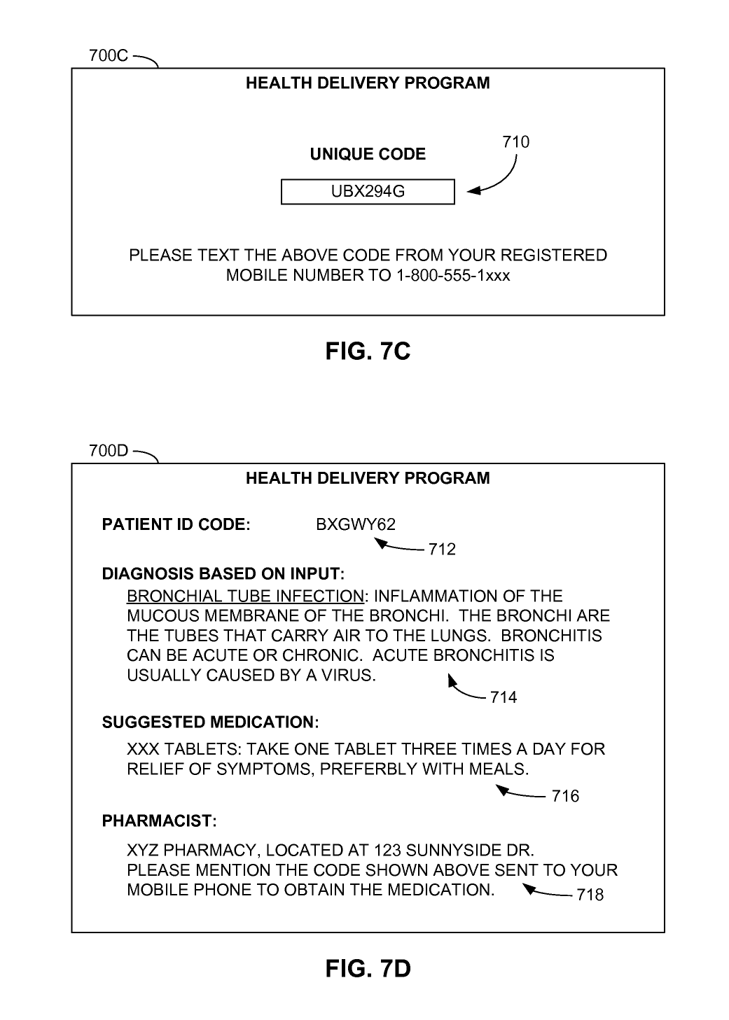

In the method 600, the communication gateway 112 may receive information describing a physical condition of a first user, as well as an identifier for the first user (operation 602). In one implementation, the communication gateway 112 provides a user interface through which a user may enter such information. FIGS. 7A and 7B, described in greater detail below, present such an interface. In response to the received information, the communication gateway 112 may generate a unique code (operation 604). The code, in one implementation, may represent an identifier associated with both the user and the user physical condition provided. The communication gateway 112 may then forward the code to a display (e.g., the display 116 of FIG. 1) for presentation to a user (operation 606), such as the user experiencing the physical conditions or symptoms, or another user. FIG. 7C depicts the presentation of such a code.

The communication gateway 112 may then receive diagnostic information from a head-end (e.g., the head-end 102 of FIG. 1) corresponding to the physical condition of the user based on the code (operation 608). In one implementation, the head-end 102 may receive the code from the communication gateway 112, a mobile phone, or another device. In some examples, the head-end 102 may forward the diagnostic information to a mobile phone or other communication device associated with one or more users. Additionally, treatment information may accompany the diagnostic information in some examples. The diagnostic information may also be accompanied with an identifier corresponding to a second user, such as a health care provider or representative. The communication gateway 112 may then forward the diagnostic information to the display 116, based on the identifier corresponding to the second user matching a stored identifier corresponding to the communication gateway 112 (operation 610). FIG. 7D illustrates the presentation of sample diagnostic information to the user.

Related to the method 600, FIGS. 7A, 7B, 7C, and 7D are example interface screens for a health delivery program or application, as mentioned above. In this particular example, the communication gateway 112 and the display 116 are presumed to be located at a health care center in which a doctor, nurse, or other representative of the center enters the information in FIGS. 7A and 7B. In FIG. 7A, the communication gateway 112 may present a first interface screen 700A via the display 116 that allows the health care representative to enter information 702 descriptive of a patient, such as a mobile number of the patient, the gender of the patient, the age of the patient, and so on. Additional information, such as a prior medical history of the patient, the mailing address of the patient, the email address of the patient, and so on, may also be entered. The representative may enter such information by way of a remote control or other input device communicatively coupled with the communication gateway 112. Also, in some examples, the communication gateway 112 may present the first interface screen 700A, as well as the other interface screens discussed below, over a particular channel reserved for such information, or via a particular source input of the display 116.

Once such information is entered, the health care application may present a second interface screen 700B, as shown in FIG. 7B, through which the health care center representative may enter the physical condition or symptoms of the patient, such as, for example, an affected area 704 of the body, a primary symptom 706, and a secondary symptom 708. In one implementation, the representative may select various symptoms and other information by way of one or more dropdown menus or other graphical mechanisms provided in the second interface screen 700B.

In response to the input provided via interface screens 700A and 700B, the communication gateway 112 may generate a unique code associated with the physical condition of the patient, as well as the identity of the patient, and present that code to the representative in a third interface screen 700C presented via the display 116 as a unique code 710. In one example, the unique code 710 is a hash code representing the diagnostic information previously entered, possibly along with the identity of the user. In one example, the representative is to transmit the code via an SMS message (e.g., a text message) to a particular phone number associated with the head-end 102. Further, the that the SMS message may originate from a phone number that has been previously registered with the head-end 102 to provide some measure of confidence that the message originates from a paying subscriber or an authorized user of the service.

In response to receiving the message including the unique code 710, the head-end 102 may then generate diagnostic information pertinent to the received condition, as well as in accordance with the patient information provided. In some examples, the head-end 102 employs an algorithm that generates a likely diagnosis, as well as appropriate treatment information, based on the physical condition of the patient entered via the second interface screen 700B. In addition, the head-end 102 may tailor the diagnosis and treatment information based on a previous medical history of the patient, as well as previous diagnosis and treatment information, associated with a previous diagnosis provided by the head-end 102. The head-end 102 may store such patient historical information from previous encounters with the patent for such a purpose. Such information may be associated with the patient by way of some identifying information of the patient, such as name, address, phone number, or the like.

The head-end 102 may then transmit or forward the diagnostic and/or treatment information to the communication gateway 112. In at least some implementations, the diagnostic and/or treatment information may also be forwarded to a mobile device number, such as the phone number associated with the health care representative that was previously registered with the head-end 102. Also in some examples, the diagnostic and/or treatment information may be forwarded to a mobile device number corresponding to any of the patient, a pharmacist selected to provide medication (or associated pharmacy or pharmaceutical dispensary), a relative of the patient authorized to receive such information, and the like. Any such potential forwarding of the diagnostic and/or treatment information may be prohibited, restricted, or otherwise regulated by any federal, state, or other law governing the transmission or provision of such information. In some cases, a video segment may also be provided to the communication gateway 112 and/or any of the above devices to present more descriptive information.

The communication gateway 112 may then forward the diagnostic and/or treatment information to the display 116 for presentation to the health care representative and/or patient. FIG. 7D depicts a fourth interface screen 700D presenting such information. The fourth interface screen 700D, for example, displays a patient ID code 712 corresponding to the patient, diagnosis information 714, suggested medication and/or treatment information 716, and pharmacist information 718 (e.g., location of the pharmacist, hours of operation, etc.) useful for obtaining the medication. In addition, the head-end 102 or the communication gateway 112 may provide the suggested medication and/or treatment information 716 to the pharmacist noted in the pharmacist information 718 via text message or other means to facilitate filling of the prescription. The suggested medication and/or treatment information 716 may be sent to the pharmacist in response to approval from the health care representative in some examples.

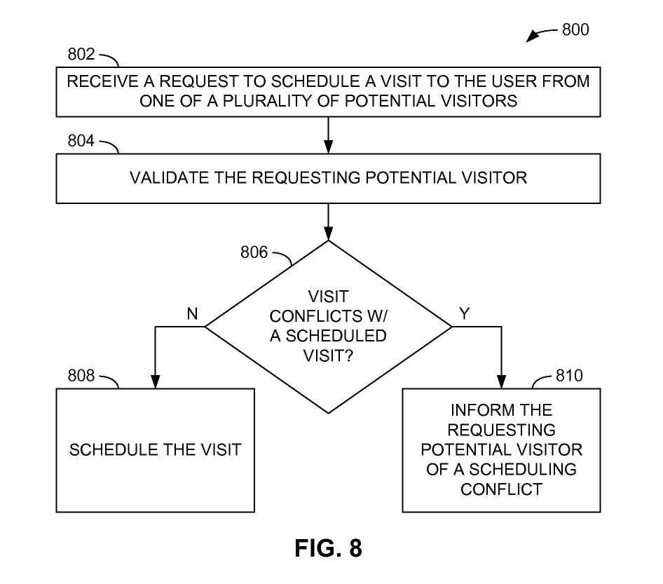

In another embodiment, FIG. 8 is a flow diagram of an example method 800 of scheduling visits, such as health-related visits, to a user of a television communication system, such as the television communication system 100 of FIG. 1. In this example method 800 and the ones that follow, the user premises 110, including the communication gateway 112, set-top box 114, and display 116, may be the home of a person needing some level of care, such as, for example, an elderly person. Further, the head-end 102 is presumed in this example to perform the method 800, but other devices, such as a computing system (e.g., the computing system 130 of FIG. 1) coupled with the head-end 102, may perform the method 800 in other examples.

In the method 800, a request to schedule a visit to the user of the communication gateway 112 may be received from one of a plurality of potential visitors (operation 802), such as, for example, a social worker, a health care professional, a relative, or a friend. The requesting potential visitor may issue the request using another communication gateway 112, a computer (e.g., a desktop, laptop, or tablet computer), or a smart phone. Further, the request may be issued by way of a text message, email message, input provided via an executing application, or the like. The request may include, for example, a date, time, and/or duration of the requested visit.

The head-end 102 may then validate the requesting potential visitor (operation 804) in response to receiving the request. For example, the requesting potential visitor may sign-in to the head-end 102 using a username and password, or utilizing a similar mechanism. In another example, the requesting potential visitor may provide the credentials for scheduling a visit by way of an identification card (e.g., a card possessing a magnetic strip, an RFID chip, or an NFC interface) that may be read by a corresponding interface coupled with a communication gateway 112 or a computing system 130. In one example, the patient or person of interest to be visited or another interested party may control which potential visitors may request a visit via this validation mechanism.

Presuming the requesting potential visitor has been successfully validated, the head-end 102 may check whether the requested visit conflicts with a previously scheduled visit (operation 806), presumably by another visitor. If a scheduling conflict is not detected, the head-end 102 may enter the requested visit in a schedule of visits maintained for the person of interest (operation 808). Such a schedule may be presented periodically or on demand of the person of interest via the communication gateway 112 of that person. If, however, a scheduling conflict is detected, the head-end 102 may inform the requesting potential visitor of the conflict (operation 810), such as by way of a response message to the communication gateway 112 of the visitor, a text message to a mobile phone of the requesting potential visitor, or via other means.

In some examples, the scheduling information maintained for a particular person may also include scheduling for events other than visits to the home of the particular person. These events may include, for example, doctor's appointments, social appointments, medication scheduling, and so on. Also, warnings of upcoming events may be provided to the person via the communication gateway 112 for presentation on the display 116, or via another path, such as text message or email. In some examples, the person receiving such a warning may be requested to return an acknowledgment, such as via the communication gateway 112 using a remote control device, or by way of return text message or email.

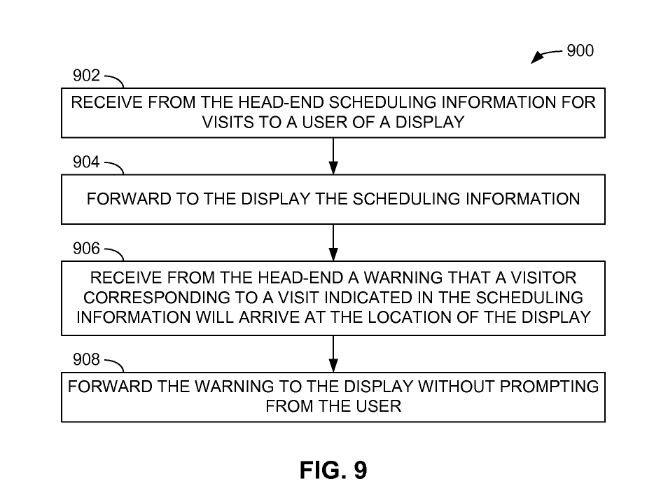

FIG. 9 is a flow diagram of an example method 900 of warning a particular user of an imminent arrival of a scheduled visitor. In the method 900, the communication gateway 112 of the user receives scheduling information for visits from the head-end 102 (operation 902), which the communication gateway 112 may forward to the display 116 (operation 904) for presentation to the user, as described above. In the case a particular user has arrived, or is soon to arrive, for a scheduled visit, the visitor may employ a smart phone or tablet computer, for example, to issue a text message or other communication to the head-end 102 indicating that fact. Accordingly, the communication gateway 112 of the person being visited may receive from the head-end 102 a warning or notification of the impending visit (operation 906), which the communication gateway 112 may forward to the display 116 for presentation to the person to be visited, without prompting from that user (operation 908). In some examples, the communication gateway 112 may interrupt a television program currently being presented to the user, or may employ a PIP display to present the warning to the user in a more discreet manner. In some implementations, the head-end 102 may provide the warning or notification to a smart phone or other computing device of the user, such as by way of text or email message.

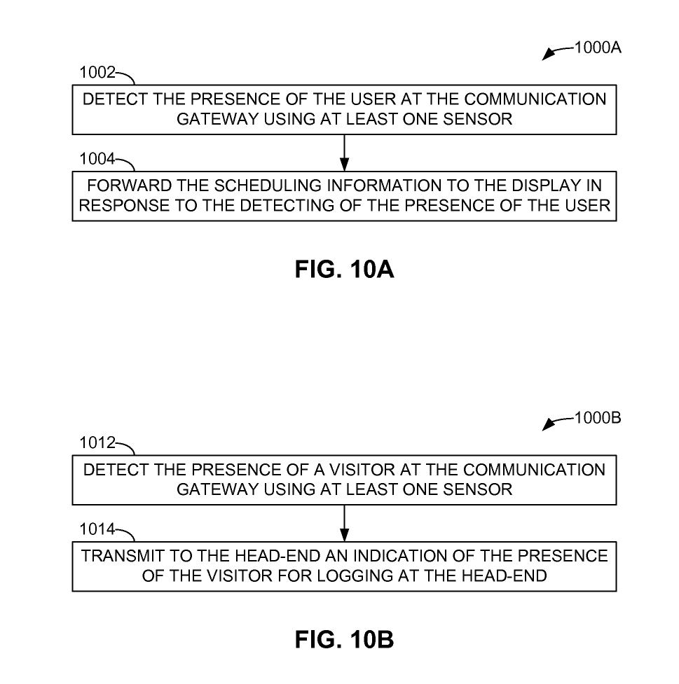

FIG. 10A is a flow diagram of an example method 1000A of detecting the presence of a user to provide scheduling information, such as that discussed above, to the user. In the method 1000A, the presence of the user is detected at the communication gateway 112 using at least one sensor (operation 1002). For example, the communication gateway 112 may be communicatively coupled to one or more sensors, such as light sensors, microphones, and so on, that may be capable of detecting motion, sounds, or other indicators that the user is present and/or moving about near the communication gateway 112. In other examples, the communication gateway 112 may be able to detect whether the user is operating the communication gateway 112, the set-top box 114, or the display 116, such as by changes in operation of those devices, use of a remote control associated with the devices, and so on. In yet other examples, the communication gateway 112 may be coupled with one or more sensors or interfaces that detect a communication device or identification device of the user that the user is holding or operating. For example, the presence and/or movement of an identification card possessing an RFID chip, NFC interface, or the like, or the presence of a smart phone, may be detected by a corresponding sensor or interface coupled with the communication gateway 112.

In response to the detecting of the presence of the user, the communication gateway 112 may forward scheduling information associated with the user that is received from the head-end 102 to the display 116 for presentation to the user (operation 1004). In some examples in which a particular communication gateway 112 and associated set-top box 114 and display 116 are shared among multiple such users, detection of the presence of a particular user facilitates an ability of the communication gateway 112 to present the scheduling information pertaining to that particular user. In addition, the user may interact with the communication gateway 112, such as via a remote control device, to control how the scheduling information (e.g., appointments for today, for tomorrow, or for the current week) is displayed to the user.

FIG. 10B is a flow diagram of an example method 1000B of logging the presence of a visitor. In a fashion similar to that discussed above, the communication gateway 112 may detect a presence or arrival of a visitor to the user of the communication gateway 112 (operation 1012). In some particular implementations, the communication gateway 112 may be coupled with a card reader or similar device that detects the presence of an identification card corresponding to the visitor. Based on the detection of the visitor, the communication gateway 112 may transmit to the head-end 102 an indication of the presence of the visitor for logging at the head-end 102 (operation 1014). The indication may also indicate the time of visitor arrival, the duration of the visit, and so forth. The visitation logs thus generated may be employed to track when various persons have visited the user to determine further scheduling of visits, missed past visits, and the like.

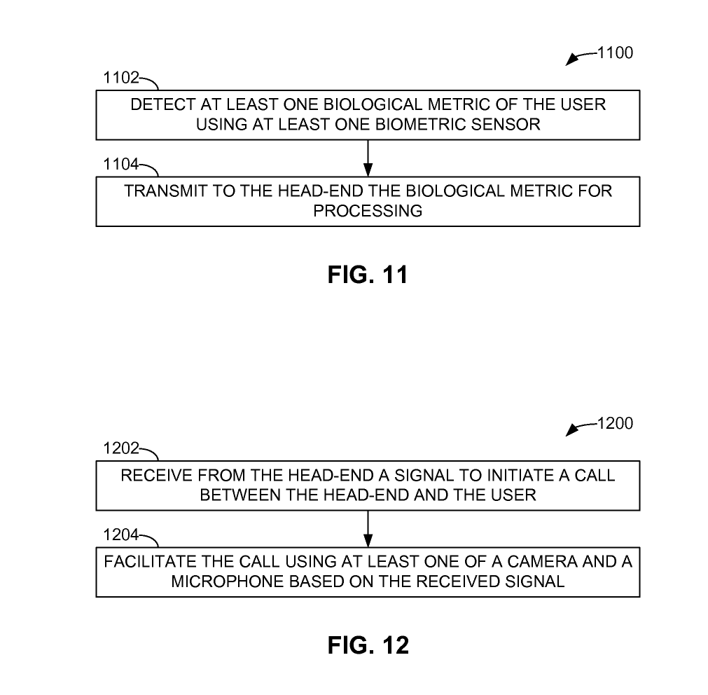

FIG. 11 is a flow diagram of an example method 1100 of detecting and processing a biological metric of a user. With respect to this method, the communication gateway 112 may be communicatively coupled with one or more biometric sensors (e.g., pulse monitor, pulse oximeter, blood pressure monitor, etc.) to which the user may engage, or that may be attached to the user. Accordingly, the communication gateway 112 may detect one or more biological metrics from the biometric sensors (operation 1102) and transmit the one or more biological metrics to the head-end 102 for processing (operation 1104). For example, the head-end 102 may monitor or track the detected biological metrics to determine a level of wellbeing of the user. Further, the head-end 102 may initiate one or more actions based on the processing of the detected metrics, such as, for example, contacting another party, such as a health care professional or an emergency services professional, to visit the user.

In another example, the head-end 102 may check the welfare of the user based on the processing of the detected metrics, or based on any other determination. FIG. 12 is a flow diagram of an example method 1200 of checking the welfare of a user. To facilitate such functionality, the communication gateway 112 may be communicatively coupled with one or more devices, such as cameras and/or microphones, which the communication gateway 112 may employ to check on, and/or communicate with, the user. In the method 1200, the communication gateway 112 may receive a signal from the head-end 102 to initiate a call between the head-end 102 and the user (operation 1202). In response to the received signal, the communication gateway 112 may facilitate the call using the at least one camera and/or microphone (operation 1204). During the call, a human monitor coupled with the head-end 102 may check in on, and possibly communicate with, the user to determine if any further actions regarding the user (e.g., a personal visit) may be appropriate.

As indicated above, one possible type of scheduled event involving the user may be the dosing schedule for one or more medications prescribed to the user. In some implementations, a pharmacist or doctor may incorporate such information into the scheduling information via the head-end 102. In addition, the scheduling information may indicate times by which a prescription should be refilled. As with other scheduled events, the communication gateway 112 may present reminders regarding upcoming medication doses to the user via the display 116. In additional examples, the communication gateway 112 may be able to determine whether the user has taken one or more scheduled medication doses.

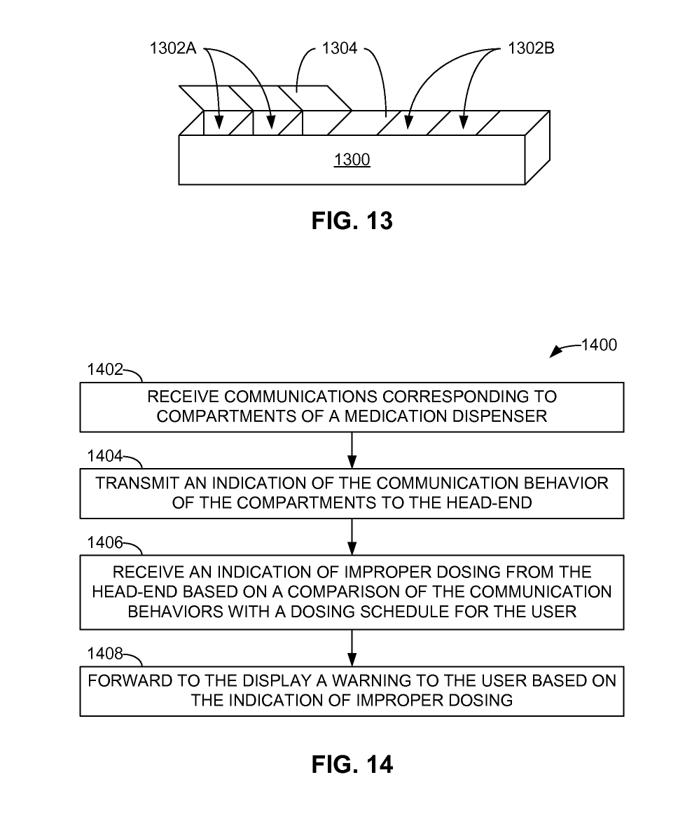

To that end, FIG. 13 is a graphical representation of an example medication dispenser 1300 employable to check the medication use of a user. In this example, the medication dispenser 1300 may include multiple compartments 1302A, 1302B (collectively, 1302) in which each compartment 1302 may contain medication that the user is to take at a particular time, or during a particular time period. Each of the compartments 1302 may correspond with a cover 1304 or lid. In one implementation, an open compartment 1302A (e.g., a compartment 1302 with an open cover 1304) may be indicative of a medication dose that the user has already taken, while a closed compartment 1302B (e.g., a compartment 1302 with a closed cover 1304) may be indicative of a medication dose that the user has not yet taken. In an implementation, the pharmacist or another person may load each compartment 1302 of the medication dispenser 1300 with the proper amount of medication, and then provide the medication dispenser 1300 to the user.

In one example, each of the compartments 1302 may be coupled with a communication interface or mechanism, such as, for example, an RFID chip or NFC interface, such that the communication mechanism is in a first state (e.g., an operative state) when the corresponding compartment lid 1304 is closed, and in a second state (e.g., an inoperative state) when the corresponding lid 1304 is open. As a result, the state of each compartment 1302 may be determined by communicative means.

Given such a medication dispenser 1300, FIG. 14 is a flow diagram of an example method 1400 of checking the medication use of a user. In the method 1400, the communication gateway 112 or the head-end 102 may receive communications corresponding to the compartments of a medication dispenser (e.g., the compartments 1302 of the medication dispenser 1300 of FIG. 13) (operation 1402). The communication gateway 112 may then transmit an indication of the communication behavior exhibited by the communication mechanism or interface of each of the dispenser compartments 1302 to the head-end 102 (operation 1404). The communication gateway 112 may then receive an indication of improper dosing based on a comparison of the communication behaviors with a dosing schedule for the user (operation 1406). The dosage schedule, in one example, may be saved at the head-end 102 as part of the scheduling information described above. The communication gateway 112 may provide a warning via the display 116 to the user indicating improper medication dosing based on the received indication of improper dosing (operation 1408). The head-end 102 may also provide a similar warning by way of a text message or email message, which may be received by way of a smart phone or computing device possessed by the user.

In at least some of the embodiments described above, health care information in varying forms may be delivered by way of a television communication system to health care professionals, patients, elderly citizens, and others. Such information may include, for example, diagnostic information, treatment/medication information, visitation schedules, and so on. Some of these embodiments may facilitate more independent living by older people and those with health challenges, while other embodiments enable the providing of health care in areas remotely located from the fully-equipped and staffed health care facilities typically associated with many metropolitan areas, all while employing communications infrastructure that is currently available in many areas across the country.

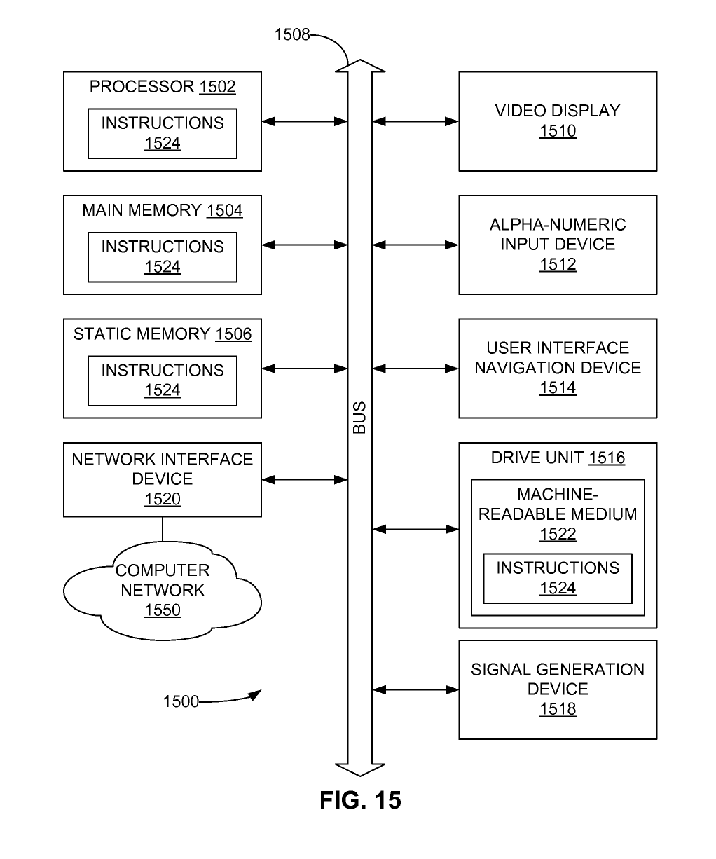

FIG. 15 illustrates a diagrammatic representation of a machine in the example form of a computer system 1500 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer, a tablet computer, a set-top box (STB), a personal digital assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1504 and a static memory 1506 which communicate with each other via a bus 1508. The computer system 1500 may further include a video display unit 1510 (e.g., a liquid crystal display (LCD) or a cathode ray tube (CRT)). The computer system 1500 also includes an alphanumeric input device 1512 (e.g., a keyboard), a user interface (UI) navigation device 1514 (e.g., a mouse), a disk drive unit 1516, a signal generation device 1518 (e.g., a speaker) and a network interface device 1520.

The disk drive unit 1516 includes a machine-readable medium 1522 on which is stored one or more sets of instructions and data structures (e.g., instructions 1524) embodying or utilized by any one or more of the methodologies or functions described herein. The instructions 1524 may also reside, completely or at least partially, within the main memory 1504 and/or within the processor 1502 during execution thereof by the computer system 1500, the main memory 1504 and the processor 1502 also constituting machine-readable media.

The instructions 1524 may further be transmitted or received over a network 1550 via the network interface device 1520 utilizing any one of a number of well-known transfer protocols (e.g., HyperText Transfer Protocol (HTTP)).

While the machine-readable medium 1522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, and optical and magnetic media.

Throughout this specification, plural instances may implement components, operations, or structures described as a single instance. Although individual operations of one or more methods are illustrated and described as separate operations, one or more of the individual operations may be performed concurrently, and the operations may be performed in an order other than that illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an application-specific integrated circuit (ASIC). A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The Abstract of the Disclosure is provided to comply with 37 C.F.R. §1.72(b), requiring an abstract that will allow the reader to quickly ascertain the nature of the technical disclosure. The Abstract is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments include more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

Although embodiments of the present disclosure have been described with reference to specific example embodiments, it will be evident that various modifications and changes may be made to these embodiments without departing from the broader scope of these embodiments. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method of providing health care remotely, the method comprising:
receiving, at a communication gateway configured to communicate with a head-end of a television communication system, information describing a physical condition of a first user and an identifier corresponding to the first user;
generating, at the communication gateway, a code based on the received information;
forwarding, to a display communicatively coupled to the communication gateway, the code for displaying on the display;
receiving, at the communication gateway from the head-end, diagnostic information corresponding to the physical condition of the first user, the diagnostic information being based on the code being received at the head-end, the diagnostic information being accompanied with an identifier corresponding to a second user; and
forwarding, to the display for displaying thereon, the diagnostic information based on the identifier corresponding to the second user matching an identifier stored in the communication gateway.

2. The method of claim 1, wherein the identifier corresponding to the second user comprises an identifier for a mobile communication device corresponding to the second user;
wherein the identifier for the mobile communication device corresponding to the second user is registered with the head-end to associate the second user with the mobile communication device corresponding to the second user; and
wherein the method further comprises receiving, at the mobile communication device corresponding to the second user, the diagnostic information based on the registration.

3. The method of claim 2, further comprising:
receiving, at the head-end from the mobile communication device corresponding to the second user, the code; and
generating, at the head-end, the diagnostic information based on the code.

4. The method of claim 3, wherein the receiving of the code comprises receiving the code via a text message from the mobile communication device corresponding to the second user.

5. The method of claim 3, wherein the generating of the code is further based on an identifier corresponding to the first user; and
wherein the generating of the diagnostic information is further based on historical diagnostic information associated with the identifier corresponding to the first user.

6. The method of claim 1, wherein the generating of the code is further based on an identifier for a mobile communication device corresponding to the first user; and
wherein the method further comprises receiving, at the mobile communication device corresponding to the first user, the diagnostic information.

7. The method of claim 1, wherein the generating of the code is further based on an identifier corresponding to the first user;
wherein the diagnostic information comprises prescription information; and
wherein the method further comprises transmitting, from the head-end to a pharmaceutical dispensary, the prescription information.

8. The method of claim 7, further comprising transmitting, from the head-end to a mobile communication device corresponding to the first user, a location of the pharmacist.

9. A system comprising:
a communication gateway communicatively coupling a display with a television communication system head-end, the communication gateway comprising at least one processor and memory comprising instructions that, when executed by the at least one processor, cause the communication gateway to perform operations comprising:
receiving, from the head-end, scheduling information for visits to a user of the display;
forwarding, to the display for displaying thereon, the scheduling information;
receiving, from the head-end, a notification that a visitor corresponding to a visit indicated in the scheduling information will arrive at the location of the display, the notification being based on a message received at the head-end from a mobile communication device of the user; and
forwarding, to the display for displaying thereon, without prompting from the user, the notification.

10. The system of claim 9, wherein the visitor is a provider of health care for the user.

11. The system of claim 9, further comprising the head-end, the head-end being configured to perform operations comprising:
receiving a request to schedule a visit to the user from one of a plurality of potential visitors;
validating, in response to receiving the request, the requesting potential visitor as authorized to access the scheduling information for the visitor, the scheduling information being maintained by the head-end;
scheduling, in response to the validating of the requesting potential visitor, the visit based on the visit not conflicting with scheduled visits indicated in the scheduling information; and
informing, in response to the validating of the requesting potential visitor, the requesting potential visitor of a scheduling conflict based on the visit conflicting with one of the scheduled visits indicated in the scheduling information.

12. The system of claim 11, wherein the validating of the requesting potential visitor comprises comparing information from a wireless identification device presented by the requesting potential visitor to validation information stored at the head-end.

13. The system of claim 11, the operations performed by the head-end further comprising:
transmitting, to the communication gateway, a first reminder of the scheduled visit for display to the user via the display.

14. The system of claim 13, the operations performed by the head-end further comprising:
transmitting, to a mobile communication device associated with the user, a second reminder of the scheduled visit.

15. The system of claim 9, wherein the operations further comprise:
receiving, from a wireless identification device presented by the user, user identification information; and
validating the user using the user identification information;
wherein the forwarding of the scheduling information is based on the validating of the user.

16. The system of claim 9, further comprising at least one sensor coupled with the communication gateway to detect a presence of the user, wherein the operations further comprise:
detecting the presence of the user at the communication gateway using the at least one sensor;
wherein the forwarding of the scheduling information is responsive to the detecting of the presence of the user.

17. The system of claim 9, further comprising at least one sensor coupled with the communication gateway to detect a presence of the visitor, wherein the operations further comprise:
detecting the presence of the visitor at the communication gateway using the least one sensor; and
transmitting, to the head-end, an indication of the presence of the visitor for logging at the head-end.

18. The system of claim 9, further comprising at least one biometric sensor coupled with the communication gateway, wherein the operations further comprise:
detecting at least one biological metric of the user using the at least one biometric sensor; and
transmitting, to the head-end, the biological metric for processing.

19. The system of claim 9, further comprising at least one of a camera and a microphone coupled with the communication gateway, wherein the operations further comprise:
receiving, from the head-end, a signal to initiate a call between the head-end and the user via the communication gateway; and
facilitating the call between the head-end and the user using the at least one of the camera and the microphone based on the received signal.

20. The system of claim 9, further comprising a first communication interface, wherein the operations further comprise:
receiving, using the first communication interface, communications corresponding to at least one of a plurality of compartments of a medication dispenser, wherein the medication dispenser comprises, for each compartment, a second communication interface that exhibits a first communication behavior when the compartment is physically open and exhibits a second communication behavior when the compartment is physically closed;
transmitting, to the head-end, an indication of the communication behavior of each of the plurality of compartments;
receiving, from the head-end, an indication of improper dosing based on a comparison of the communication behavior of each of the plurality of compartments with a dosage schedule corresponding to the user; and
forwarding, to the display for displaying thereon, a warning to the user based on the indication of improper dosing.

21. A tangible computer-readable storage medium comprising instructions that, when executed by at least one processor of a communication gateway configured to communicate with a television communication system head-end, cause the communication gateway to perform operations comprising:
receiving, at the communication gateway, information associating a user with the communication gateway;
receiving, at the communication gateway from the head-end, health care information related specifically to the user and a gateway identifier associated with the user;
forwarding, to a display communicatively coupled to the communication gateway, the health care information based on the gateway identifier corresponding to the communication gateway.
